(19) United States
(12) Patent Application Publication
(10) Pub. No.: US 2005/0135735 A1
(43) Pub. Date: Jun. 23, 2005

(54) Architectures for optical networks

(76) Inventors: Bernhard Deutsch, Hickory, NC (US); William S. Jackman, Hickory, NC (US); Kenneth F. Dunn, Statesville, NC (US)

Correspondence Address: CORNING CABLE SYSTEMS LLC, P O BOX 489, HICKORY, NC, 28603, US

(21) Appl. No.: 10/742,535

(22) Filed: Dec. 19, 2003

(51) Int. Cl. G02B 6/28

(52) U.S. Cl. 385/24

(57) ABSTRACT

An optical network that can span increased distances using a feeder link portion, at least one 1:N splitter, a distribution link portion, and a drop link portion for servicing end users. The at least one 1:N splitter being in optical communication between the feeder link portion and the distribution link portion. In one embodiment, the feeder link portion has at least one optical waveguide with a predetermined Stimulated Brillouin Scattering(SBS) threshold and the distribution link portion having at least one optical waveguide having a predetermined Stimulated Brillouin Scattering (SBS) threshold. The optical network having a SBS threshold ratio that is greater than one. The SBS threshold ratio being defined as the predetermined SBS threshold of the feeder link portion divided by the predetermined SBS threshold of distribution link portion.

### FIELD OF THE INVENTION

The present invention relates generally to optical networks. More specifically, the invention relates to architectures that can span increased distance for servicing high-bandwidth end users.

### BACKGROUND OF THE INVENTION

Fiber optic cables include optical waveguides such as optical fibers that form networks for transmitting optical signals, for example, voice,.video, and/or data information. These networks have losses that occur during transmission of the optical signal along the network. Losses include factors such as attenuation loss along the optical waveguide,. insertion loss of connectors, and splitter losses. In addition to these losses there are also non-linear losses such as Stimulated Brillouin Scattering (SBS) and Raman Scattering.

SBS occurs after the optical signal launched into an optical waveguide exceeds a given threshold power level. When the threshold power level is exceeded, a portion of the optical signal is returned in a direction opposite to the direction of launch. Moreover, SBS effects are length dependent so that when a launched signal exceeds the threshold power level the SBS effects increase with the distance traveled. Consequently, active optical networks have been developed that allow for increased threshold power levels before SBS threshold occurs. One type of active optical network works by modulating the optical signal, thereby increasing the SBS threshold power level. Since active optical networks require additional components and/or equipment it makes them relatively expensive to install and maintain.

As the demand for increased network bandwidth continues to grow, service providers must provide reliable, economical, and scalable optical networks that can handle the increased bandwidth demand for a variety of customers. For instance, SBS concerns constrain certain high bandwidth applications such as analog video signals being transmitted at the 1550 nm wavelength. The constraint on the network occurs because the typical analog optical receiver has a limited sensitivity compared with a digital optical receiver. There are also passive optical networks that do not use active components in operation, but the passive optical networks are constrained by the reach of the passive network due to SBS effects.

### SUMMARY OF THE INVENTION

The present invention is directed to an optical network having a feeder link portion, at least one 1:N splitter, a distribution link portion, and a drop link portion. The feeder link portion includes at least one optical waveguide having a predetermined Stimulated Brillouin Scattering(SBS) threshold and the distribution link portion includes at least one optical waveguide having a predetermined Stimulated Brillouin Scattering (SBS) threshold. The at least one 1:N splitter being in optical communication between the feeder link portion and the distribution link portion. A SBS threshold ratio being defined as the predetermined SBS threshold of the feeder link portion divided by the predetermined SBS threshold of distribution link portion, wherein the SBS threshold ratio is greater than one. The optical network has at least one drop link portion having at least one optical waveguide for communicating an optical signal from the feeder link portion.

The present invention is also directed to an optical network including a feeder link portion, a distribution link portion, at least one 1:N splitter, and a drop link portion. The feeder link portion has at least one optical waveguide receiving a predetermined launch power having a length (L1), the at least one optical waveguide of the feeder link having a predetermined Stimulated Brillouin Scattering(SBS) threshold, and a predetermined normalized optical waveguide loss (WL1). The distribution link portion having at least one optical waveguide having a length (L2), a predetermined optical normalized waveguide loss (WL2), and a predetermined Stimulated Brillouin Scattering (SBS) threshold, wherein the predetermined SBS threshold of distribution link portion is less than to the predetermined SBS threshold of the feeder link portion. The at least one 1:N splitter being in optical communication between the feeder link portion and the distribution link portion and the 1:N splitter having a predetermined splitter loss, wherein a splitter loss (SL) of the optical network is the sum of splitter losses along a network path. The drop link portion having at least one optical waveguide having a length (L3) and a predetermined optical waveguide loss, the drop link portion is operative for communicating an optical signal from the feeder link portion with a minimum received power (MR Power). A link loss budget (LLB) of the optical network is the launch power into the feeder link portion minus the minimum received power (MR Power) at the end of the drop link portion. Additionally, a total optical waveguide loss (TWL) is calculated as the sum of WL1*L1+WL2*L2+WL3*L3, and the optical network has a predetermined connection loss (CL) along a network path, wherein the maximum reach of the optical network being calculated as the sum of L1+L2+L3 which satisfies a relationship of LLB=SL+CL+TWL.

Additionally, the present invention is directed to an optical network including a feeder link portion, a distribution link portion, at least one 1:N splitter, and a drop link portion. The feeder link portion comprising at least one optical waveguide having a predetermined Stimulated Brillouin Scattering(SBS) threshold. The distribution link portion comprising at least one optical waveguide having a predetermined Stimulated Brillouin Scattering (SBS) threshold, wherein the predetermined SBS threshold of distribution link portion is less than the predetermined SBS threshold of the feeder link portion. The at least one 1:N splitter being in optical communication between the feeder link portion and the distribution link portion. The drop link portion having at least one optical waveguide for communicating an optical signal from the feeder link portion, the power transmitted at the end of the drop link portion being about −6 dBm or greater.

### BRIEF DESCRIPTION OF THE FIGS.

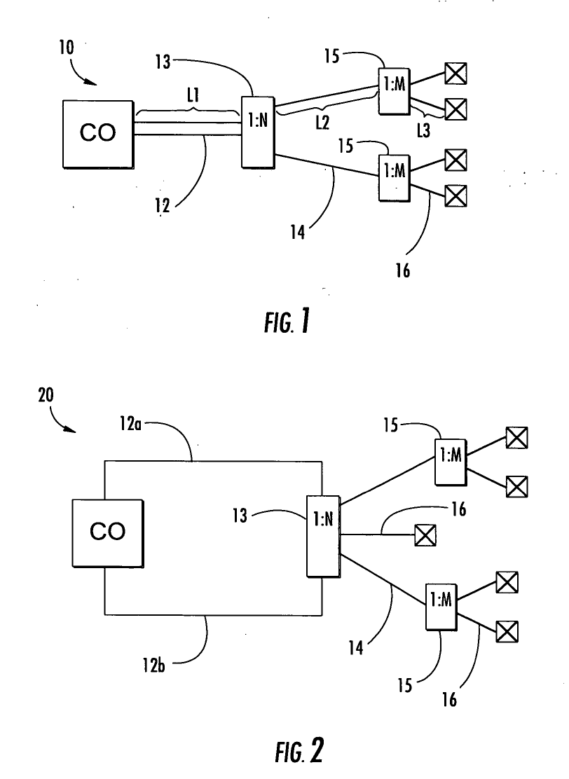

FIG. 1 is a schematic representation of a passive optical network according to the present invention.

FIG. 2 is a schematic representation of another passive optical network according to the present invention.

### DETAILED DESCRIPTION OF THE INVENTION

The present invention will now be described more fully hereinafter with reference to the accompanying drawings showing preferred embodiments of the invention. The invention may, however, be embodied in many different forms and should not be construed as limited to the embodiments set forth herein; rather, these embodiments are provided so that the disclosure will fully convey the scope of the invention to those skilled in the art. The drawing are not necessarily drawn to scale but are configured to clearly illustrate the invention.

Illustrated in FIG. 1 is a schematic representation of an exemplary optical network 10 according to the present invention. As used herein, optical network means the portion of a communication network that is on the end user side of a central office or central switch. In other words, the optical network is generally defined from the connection point at the central office or central switch to the connection point that feeds a receiver at the end user location. Optical network 10 includes a feeder link 12 having a length L1, a first 1:N splitter/combiner 13 (hereinafter splitter), a distribution link 14 having a length L2, a second 1:M splitter 15, and a drop link 16 having a length L3. In this case, optical network 10 is a passive optical network (PON) because it does not amplify or regenerate the optical signal between the connector at the central office and the connector to the end user. In other words, no active equipment is between the connectors of the optical network. Additionally, optical network 10 may use any suitable split ratio for splitters 13 and 15.

PONs have limited reaches when transmitting signals such as analog video signals at 1550 nm due to network losses. The maximum reach is about equal to the sum of the lengths of the optical links that provide a usable and reliable optical signal at the end of drop link 16. In the case of PON 10, the maximum reach would be the sum of lengths L1, L2, and L3 that still provide a usable and reliable signal. Additionally, the maximum reach of PONs may be extended by modulating the launched optical signal to increase the threshold power at which SBS effects occur. Among other factors, the maximum reach of PONs is restricted by the launch power into the feeder link.

The optical networks of the present invention are advantageous for transmitting a relatively high launch power before the onset of Stimulated Brillouin Scattering SBS, thereby allowing for longer drives into the network with the feeder link 12 while maintaining signal strength and/or quality. Additionally, a longer drive into the network with the feeder link allows for optical networks with longer reaches. In one embodiment, feeder link 12 is about 50 percent or more of the network reach, thereby reducing the associated costs of the installation and maintainance of the optical-network. However, feeder link 12 may be about 70 percent or more of the network reach, but shorter lengths are possible.

In the case of analog video signals transmitted at 1550 nm, a minimum received power (MR Power) should be about −6 dB or greater for the analog optical receiver. However, other suitable power levels are possible according to the present invention. Moreover, the concepts of the present invention may be used for applications other than analog video transmission.

Specifically, optical networks of the present invention allow economical deployment of a high bandwidth network by using a feeder link that allows for higher launch powers before non-linear losses such as SBS occur. In other words, expensive equipment such as repeaters and regenerators are not necessary to carry high bandwidth traffic over relatively long distances. This is especially true if the optical network has redundant network links, thereby allowing the main connection to go offline for service, maintenance and/or upgrades while maintaining communication.

Table 1 depicts the advantages of several exemplary optical networks of the present invention. Specifically, Table 1 compares the maximum distances for PONs of the present invention with conventional PONs using different split ratios for 1:N splitter 13. During operation, feeder link 12 communicates the launched optical signal to a 1:N splitter 13, which may communicate with up to N distribution links 14. As shown in the second column of Table 1, 1:N splitter 13 has a loss that generally increases as the split ratio increases. Additionally, the PONs have other predetermined losses to account for such as connector losses and fiber losses normalized per unit length. For comparison purposes the predetermined losses for common components of the different PONs of Table 1 are the same, namely, a 4 dB connector loss calculated as 8 connectors @ 0.5 dB/connector and respective normalized fiber losses of 0.25 dB/km. Likewise, lengths for the distribution links and drop links for the respective optical networks are the same for comparison purposes. In practice, respective links 12, 14 and 16 of optical network 10 can have different respective normalized fiber loss values that are multiplied by lengths L1, L2, and L3 respectively. Additionally, the numbers and types of optical connectors may vary in practice.

As shown, as the splitter loss increases it limits the maximum distance a feeder link of the conventional PON can travel into the PON. Thus, the splitter loss constrains the length of the feeder link into the conventional PON. In other words, as the number of splits of the feeder link increases, the conventional PON would locate the first 1:N splitter closer to the central office. Other network architectures such as active networks are possible but are generally more expensive to maintain and install.

On the other hand, the present invention allows for PONs with longer network reaches. As shown by Table 1, the present invention increases the maximum network reach across the range of the first 1:N ratios. Additionally, the invention is also advantageous because the higher the splitter ratio the greater the percent increase in the maximum feeder link length. In other words, a conventional PON only has a network reach of 26 km with the first splitter ratio being 1:16 because of non-linear effects such as SBS. But the present invention can drive a feeder link 28 km with the splitter ratio being 1:32 since it can accommodate higher launch powers into the feeder link.

TABLE 1

| | | | Maximum Network | |
|---|---|---|---|---|
| | | Conventional | Reach of the | Percent |
| Splitter | Splitter | Maximum | Present | Increase in |
| Ratio | Loss | Network Reach | Invention | Length |
| 2 | 4 dB | 64 km | 76 km | 18% |
| 4 | 7 dB | 52 km | 64 km | 23% |
| 8 | 10 dB | 40 km | 52 km | 30% |
| 16 | 13 dB | 26 km | 40 km | 53% |
| 32 | 16 dB | 16 km | 28 km | 75% |
| 64 | 19 dB | 4 km | 16 km | 300% |
| 128 | 22 dB | N/A | 4 km | N/A |

The optical network architectures of the present invention use a feeder link 12 having an optical waveguide that allows for higher launch power before the onset of SBS occurs. As used herein, the onset of SBS means that about ten percent of the launch power is returned in the opposite direction as SBS. By permitting higher launch powers into the feeder link, the optical network can have longer maximum network reaches and/or larger split ratios at 1:N splitter 13. However, the concepts of the present invention can be practiced with PONs or other optical networks that have network reaches that are less than the maximum network reach of Table 1.

The optical networks of the present invention use optical waveguides in feeder link 12 having a predetermined SBS threshold that is greater to or equal to a predetermined SBS threshold of the optical waveguide of distribution link 14. For instance, feeder link 12 is an optical waveguide such as disclosed in U.S. Pat. No. 6,542,683 and distribution link 14 is an optical fiber such as SMF-28 available from Corning, Incorporated. However, other suitable optical waveguides may be used for either feeder link 12 or distribution link 14 within the scope of the present invention.

Preferred embodiments of the present invention have a threshold SBS ratio that is about equal to or greater than one. As used herein, the threshold SBS ratio means the SBS threshold of the feeder link divided by the SBS threshold of the distribution link. By way of example, feeder link 12 has a predetermined SBS threshold of about 21 dBm or more and distribution link 14 has a predetermined SBS threshold of about 18 dBm. In other words, feeder link 12 can handle twice the absolute power compared with distribution link 14 before the SBS threshold is reached. In this case, the SBS threshold ratio is about 1.16 calculated using dB power levels, but other suitable threshold SBS ratios are possible. If the SBS threshold ratio is calculated using absolute power levels for the given example, the ratio is about 2.

Launch factors for the optical signal influence the SBS threshold for any given optical network. For instance, if the optical signal is continuous the SBS threshold is generally lower, but on the other hand if the optical signal is modulated the SBS threshold generally increases. Thus, the SBS threshold will depend on the launched signal. By way of example, low end values for SBS threshold may be about 10 dBm or 13 dBm for a given launch conditions, but other values are possible with the concepts of the present invention. Thus, when comparing SBS thresholds conditions should be similar for a valid comparison.

As shown in FIG. 1, distribution link 14 may have its signal split at second 1:M splitter 15, where it may communicate with up to N drop links 16. Drop links are used for bringing the signal to the end user. Specifically, the PON ends at an optical connector that is used for the termination to, for example, an opto-electrical transducer. The opto-electrical transducer is used for converting the optical signal to an electrical signal for the end user, but it is not a portion of optical network 10.

Many different configurations of optical networks are possible with the concepts of the present invention. For instance, each 1:M splitter 15 may vary depending upon requirements. Likewise, optical networks can have extra levels or eliminate levels between the distribution link and the drop links. For instance, optical networks of the present invention can have the feeder link split directly to the drop links as shown in FIG. 1. Whatever the configuration, the optical network should have an adequate and reliable signal suitable for detection at the end of the drop link.

Additionally, other PONs and/or active optical networks are possible with the concepts of the present invention. For instance, PONs may have a ring architecture, for example, as discussed U.S. Pat. No. 6,351,582. FIG. 2 depicts PON 20 using an exemplary ring architecture. In this embodiment, there is a primary feeder link 12a and a secondary feeder link 12b connected to the remainder of PON 20. Optical signals coming from the central office can either travel in one direction around the loop or in both directions to reach 1:N splitter 13. In other configurations secondary feeder link 12b may be used for back-up communication. Other configurations can also be used with the concepts of the present invention.

Furthermore, the concepts of the present invention may be used with other techniques that delay onset of SBS to further increase the network reach. For instance, the optical signal may be dithered before launching into the feeder link. Dithering modulates the wavelength of the optical signal as discussed in U.S. Pat. No. 6,166,837, the disclosure of which is incorporated herein by reference. However, other systems and techniques may be used to modulate the optical signal along with the concepts of the present invention.

Many modifications and other embodiments of the present invention, within the scope of the appended claims, will become apparent to a skilled artisan. For example, optical networks of the present invention can have any suitable network reach. Additionally, the present invention can include other suitable configurations, hybrid designs, structures and/or equipment. Therefore, it is to be understood that the invention is not limited to the specific embodiments disclosed herein and that modifications and other embodiments may be made within the scope of the appended claims. Although specific terms are employed herein, they are used in a generic and descriptive sense only and not for purposes of limitation. The invention has been described with reference to PONs and other optical networks having a feeder link, a distribution link, and a drop link, but the inventive concepts of the present invention are applicable to other suitable network configurations as well.

1. An optical network comprising:
a feeder link portion, the feeder link portion comprising at least one optical waveguide having a predetermined Stimulated Brillouin Scattering(SBS) threshold;
a distribution link portion, the distribution link portion comprising at least one optical waveguide having a predetermined Stimulated Brillouin Scattering (SBS) threshold, wherein a SBS threshold ratio is defined by the predetermined SBS threshold of the feeder link portion divided by the predetermined SBS threshold of distribution link portion, the SBS threshold ratio being greater than one;
at least one l:N splitter, the at least one 1:N splitter being in optical communication between the feeder link portion and the distribution link portion; and
a drop link portion, the drop link portion having at least one optical waveguide for communicating an optical signal from the feeder link portion.

2. The optical network according to claim 1, wherein the predetermined SBS threshold of the feeder link portion is the defined as a launch power level where about 10% of the forward transmitted power is returned in the reverse direction as Brillouin scatter, the predetermined threshold of the feeder link portion being about lOdBm or more for a modulated optical signal.

3. The optical network according to claim 1, wherein the predetermined SBS threshold of the feeder link portion is the defined as a launch power level where about 10% of the forward transmitted power is returned in the reverse direction as Brillouin scatter, the predetermined threshold of the feeder link portion being about 13 dBm or more for a modulated optical signal.

4. The optical network according to claim 1, wherein at least one 1:N splitter has a split ratio of 1:32 or greater.

5. The optical network according to claim 1, wherein the optical network has a reach of about 10 km or more and the at least one splitter has a split ratio of 1:32 or greater.

6. The optical network according to claim 1, wherein the optical network has a reach of about 20 km or more and the at least one splitter has a split ratio of 1:4 or greater.

7. The optical network according to claim 1, wherein the optical network portion has a reach of about 20 km or more.

8. The optical network according to claim 1, wherein the predetermined SBS threshold of the feeder link portion is the defined as a launch power level where about 10% of the forward transmitted power is returned in the reverse direction as Brillouin scatter, the predetermined threshold of the feeder link portion being about equal to or greater than the launch power into the feeder link portion.

9. The optical network according to claim 1, further comprising a second 1:M splitter being in optical communication between the distribution link portion and the drop link portion.

10. The optical network according to claim 1, wherein the optical network is a passive optical network (PON).

11. An optical network comprising:
a feeder link portion, the feeder link portion comprising at least one optical waveguide receiving a predetermined launch power having a length (L1), the at least one optical waveguide having a predetermined Stimulated Brillouin Scattering(SBS) threshold, and a predetermined normalized optical waveguide loss (WL1);
a distribution link portion, the distribution link portion comprising at least one optical waveguide having a length (L2), a predetermined optical normalized waveguide loss (WL2), and a predetermined Stimulated Brillouin Scattering (SBS) threshold, wherein the predetermined SBS threshold of distribution link portion is less than to the predetermined SBS threshold of the feeder link portion;
at least one 1:N splitter, the at least one 1:N splitter being in optical communication between the feeder link portion and the distribution link portion, the at least one 1:N splitter having a predetermined splitter loss, wherein a splitter loss (SL) of the optical network is the sum of splitter losses along a network path;
a drop link portion, the drop link portion having at least one optical waveguide having a length (L3) and a predetermined optical waveguide loss, the drop link portion is operative for communicating an optical signal from the feeder link portion with a minimum received power (MR Power);
a link loss budget (LLB) of the optical network being the launch power into the feeder link portion minus the minimum received power (MR Power) at the end of the drop link portion, a total optical waveguide loss (TWL) being calculated as the sum of WL1*L1+WL2*L2+WL3*L3, and the optical network having a predetermined connection loss (CL) along a network path, wherein the maximum reach of the optical network being calculated as the sum of L1+L2+L3 which satisfies a relationship of LLB=SL+CL+TWL.

12. The optical network according to claim 11, wherein a reach of the feeder link portion is about 50% or more of the maximum reach of the feeder link.

13. The optical network according to claim 11, wherein a reach of the feeder link portion is about 70% or more of the maximum reach of the feeder link.

14. The optical network according to claim 11, wherein the predetermined launch power into the feeder link portion is about lOdBm or more for a modulated optical signal.

15. The optical network according to claim 11, wherein the predetermined launch power into the feeder link portion is about 13dBm or more for a modulated optical signal.

16. The optical network according to claim 11, wherein at least one 1:N splitter has a split ratio of 1:32 or greater.

17. The optical network according to claim 11, wherein the optical network has a reach of about 10 km or more.

18. The optical network according to claim 11, wherein the optical network has a reach of about 20 km or more.

19. The optical network according to claim 11, wherein the minimum received power of the drop link portion is about −6 dBm or greater.

20. The optical network according to claim 11, wherein the predetermined SBS threshold of the feeder link portion is the defined as a launch power level where about 10% of the forward transmitted power is returned in the reverse direction as Brillouin scatter, the predetermined threshold of the feeder link portion being about equal to or greater than the launch power into the feeder link portion.

21. The optical network according to claim 11, further comprising a second 1:M splitter being in optical communication between the distribution link portion and the drop link portion, the second 1:M splitter having a predetermined splitter loss (SL2) which is a component of (SL).

22. The optical network according to claim 11, wherein the optical network is a passive optical network (PON).

23. An optical network comprising:
a feeder link portion, the feeder link portion comprising at least one optical waveguide having a predetermined Stimulated Brillouin Scattering(SBS) threshold;
a distribution link portion, the distribution link portion comprising at least one optical waveguide having a predetermined Stimulated Brillouin Scattering (SBS) threshold, wherein the predetermined SBS threshold of distribution link portion is less than the predetermined SBS threshold of the feeder link portion;
at least one 1:N splitter, the at least one 1:N splitter being in optical communication between the feeder link portion and the distribution link portion; and
a drop link portion, the drop link portion having at least one optical waveguide for communicating an optical signal from the feeder link portion, the power transmitted at the end of the drop link portion being about −6 dBm or greater.

24. The optical network according to claim 23, wherein the predetermined SBS threshold of the feeder link portion is the defined as a launch power level where about 10% of the forward transmitted power is returned in the reverse direction as Brillouin scatter, the predetermined threshold of the feeder link portion being about 10 dBm or more for a modulated optical signal.

25. The optical network according to claim 23, wherein the predetermined SBS threshold of the feeder link portion is the defined as a launch power level where about 10% of the forward transmitted power is returned in the reverse direction as Brillouin scatter, the predetermined threshold of the feeder link portion being about 13dBm or more for a modulated optical signal.

26. The optical network according to claim 23, wherein at least one 1:N splitter has a split ratio of 1:32 or greater.

27. The optical network according to claim 23, wherein the optical network has a reach of about 10 km or more and the at least one splitter has a split ratio of 1:32 or greater.

28. The optical network according to claim 23, wherein the splitter has a split ratio of 1:2 or greater.

29. The optical network according to claim 23, wherein the optical network has a reach of about 20 km or more.

30. The optical network according to claim 23, wherein the predetermined SBS threshold of the feeder link portion is the defined as a launch power level where about 10% of the forward transmitted power is returned in the reverse direction as Brillouin scatter, the predetermined threshold of the feeder link portion being about equal to or greater than the launch power into the feeder link portion.

31. The optical network according to claim 23, further comprising a second 1:M splitter being in optical communication between the distribution link portion and the drop link portion.

32. The optical network according to claim 23, wherein the optical network is a passive optical-network (PON).
